(19) United States
(12) Patent Application Publication
(10) Pub. No.: US 2026/0138107 A1
(43) Pub. Date: May 21, 2026

(54) FIXED BED REACTOR BASED ON THE PRINCIPLE OF THERMOELECTRIC FOR IN-SITU HEAT REMOVAL AND IN-SITU TEMPERATURE MEASUREMENT OF STRONG EXOTHERMIC REACTIONS

(71) Applicants: Quzhou Institute for Innovation in Resource Chemical Engineering, Quzhou (CN); Beijing University of Chemical Technology, Beijing (CN)

(72) Inventors: Junting FENG, Beijing (CN); Qian WANG, Beijing (CN); Xiaomeng CHEN, Beijing (CN); Fengyu ZHANG, Beijing (CN); Lulu XIE, Beijing (CN); Xue DUAN, Beijing (CN)

(73) Assignees: Quzhou Institute for Innovation in Resource Chemical Engineering, Quzhou (CN); Beijing University of Chemical Technology, Beijing (CN)

(21) Appl. No.: 19/277,771

(22) Filed: Jul. 23, 2025

(30) Foreign Application Priority Data
Nov. 19, 2024 (CN) 202411657162.2

(51) Int. Cl. B01J 8/06

(52) U.S. Cl. CPC B01J 8/067; B01J 2208/00194; B01J 2208/065

(57) ABSTRACT

A fixed bed reactor based on the principle of thermoelectric to achieve in-situ heat removal and in-situ temperature measurement for strong exothermic reactions involves the field of fixed bed devices for heat reuse of exothermic reactions. Specifically, it relates to the field of fixed bed devices based on the principle of thermoelectric for timely heat removal of strong exothermic reactions, and can also measure and monitor the temperature and heat of exothermic reactions from multiple angles, enhancing the heat transfer of the catalytic bed layer, effectively eliminating or reducing the generation of reaction hotspots, and avoiding catalyst deactivation. The utility model comprises a fixed bed reaction tube, and the top of the fixed bed reaction tube is equipped with an infrared temperature measurement system, a potential detection system, and an electric energy collection system.

### CROSS-REFERENCE TO RELATED APPLICATIONS

This application claims priority to Chinese Patent Application No. 202411657162.2, filed on Nov. 19, 2024, the content of which is incorporated herein by reference in its entirety.

### TECHNICAL FIELD

The present application belongs to a reactor suitable for thermoelectric to achieve in-situ heat removal and in-situ temperature measurement in gas-phase exothermic reactions, and particularly relates to a fixed bed reactor suitable for acetylene hydrogenation to ethylene reaction.

### BACKGROUND

Many important chemical processes are strongly exothermic multiphase catalytic reactions, such as acetylene hydrogenation, where the total enthalpy of the reaction changes to −176 kJ·mol⁻¹. The total enthalpy of the side reaction acetylene hydrogenation to ethane changes by as much as −312 kJ·mol⁻¹. During the reaction, a large amount of heat is released instantly. If the heat cannot be quickly removed, the large amount of heat released instantly can easily cause local overheating, which not only increases the probability of side reactions, but also instantly leads to catalyst failure, resulting in unstable reaction conversion rate and selectivity, and reduced system efficiency. More seriously, the instantaneous release of a large amount of heat can easily cause problems such as system overheating and pressure loss, which can damage the process equipment and, in severe cases, cause major safety accidents such as explosions, fires, and casualties. Therefore, in order to ensure the normal progress of the catalytic reaction, it is necessary to remove the heat in a timely manner.

For strongly exothermic reactions, many types of reactors have been designed and many methods for heat removal have been proposed. Chinese Patent Application Publication CN118253267A proposes a reaction heat utilization device for the preparation of 1,2-dichloroethane by ethylene oxychlorination. The fluidized bed reactor device is divided into a dense phase zone and a dilute phase zone. By setting up heat exchange tube bundles in the dilute phase zone, preheating the feed gas with reaction gas, extracting waste heat from gas-phase products, reducing catalyst carryover loss, equipment investment, and energy consumption. By secondary addition of raw gas and thermal extraction diversion, the raw gas is separately added, and the bottom reaction heat is guided to the heat removal tube bundle, which improves the selectivity and purity of 1,2-dichloroethane. But the thermal conductive sheet only removes some of the surrounding heat and cannot solve the “hot spot” of the catalyst bed. Chinese Patent Application Publication CN1260237A proposes using thermally conductive metal particles as inert diluents in exothermic reactions to reduce and avoid the formation of hot spots in a fixed bed. This method only transfers heat from the catalytic active sites to the diluent and does not fully utilize the heat. Thermoelectric materials, as functional materials that can achieve bidirectional conversion of thermal and electrical energy, have shown great potential for applications in waste heat utilization, solid-state refrigeration technology, and other fields, providing innovative solutions to the current energy shortage problem. Thermoelectric materials are the core of achieving thermoelectric, and their performance directly affects the efficiency of thermal energy conversion. By using thermoelectric to remove heat from exothermic reactions while measuring temperature and storing electrical energy, the problem of catalyst deactivation caused by additional heat generation can be avoided.

### SUMMARY

The purpose of the present application is to provide a fixed bed temperature measuring reactor based on the concept of thermoelectric, which can enhance the heat transfer of the catalytic bed layer, prepare composite materials by doping thermoelectric materials with catalysts, and directly convert thermal energy into electrical energy through thermoelectric, achieving the removal of heat from strong exothermic reactions. On the other hand, the temperature of the reaction process can be detected in situ by measuring the electrical signal intensity of thermoelectric materials, and the electrical energy can be collected.

To achieve the above objectives, the present application provides the following technical solution.

A fixed bed reactor suitable for in-situ heat removal and in-situ temperature measurement in gas-phase exothermic reactions, comprising a heating jacket and a fixed bed reaction tube. The heating jacket is installed outside the fixed bed reaction tube. a catalyst bed is installed inside the fixed bed reaction tube. Two ends of the fixed bed reaction tube are respectively equipped with inlet and outlet ports. a thermocouple is installed inside the fixed bed reaction tube, with one end extending to the catalyst bed and the other end extending outside the fixed bed reaction tube. The fixed bed reactor further comprises at least one of the electrical signal detection system, electric energy storage system and the infrared temperature measurement system.

The electric energy storage system comprises rechargeable batteries, potential difference meters, external catalyst filling boxes, and external catalysts. the rechargeable battery, potentiometer, external catalyst filling box, and catalyst bed are connected to form a closed circuit.

The constant temperature of the catalytic bed is a basic requirement for ensuring the normal operation of the catalytic process, and the lens of infrared thermometer 1 is relatively large. If infrared temperature measurement is carried out on the side of the fixed bed, it will affect the insulation effect of the heating furnace, thereby affecting the progress of the catalytic process. As mentioned earlier, the present application measures temperature at the top of the reaction tube in a fixed bed.

Compared with existing technologies, based on the principle of thermoelectric, this application proposes to combine acetylene selective hydrogenation catalyst with thermoelectric materials to remove the heat of exothermic reaction and avoid the generation of hot spots in the catalytic bed, while ensuring the normal progress of catalytic reaction and not increasing the processing difficulty of the reactor.

This application combines infrared temperature measurement, electrical signal detection and collection, and fixed bed reactor to design the inner diameter, material, and inlet and outlet modules of the fixed bed reaction tube to meet the detection conditions, facilitate real-time monitoring of the reaction process, and measure temperature from multiple angles to obtain the true temperature of the catalytic reaction, further analyze the catalytic process, and improve the objective effectiveness of catalyst performance evaluation.

### BRIEF DESCRIPTION OF THE DRAWINGS

FIG. 1 is a schematic diagram of the fixed bed reactor and infrared temperature measurement system of the present application.

FIG. 2 is a schematic diagram of the fixed bed reactor and electrical signal detection and storage system of the present application.

FIG. 3 shows the catalyst loading and support frame of the fixed bed reactor of the present application.

FIG. 4 is a front view of the catalyst in the fixed bed reactor of the present application.

FIG. 5 is a top view of the catalyst in the fixed bed reactor of the present application.

### DETAILED DESCRIPTION OF THE EMBODIMENTS

The following provides a further detailed explanation of the novel technical solution of the present application, but it is not intended to be a limitation of the present application.

A fixed bed reactor suitable for thermoelectric to achieve in-situ heat removal of strong exothermic reactions comprises a fixed bed reaction tube, and an infrared temperature measurement system at the top of the fixed bed reaction tube. There are inlet and outlet ports on the side of the fixed bed reaction tube. The fixed bed reaction tube is equipped with a thermocouple inlet. A catalyst bed 4 is installed inside the reaction tube, which is filled with catalyst. A heating jacket 3 is installed outside the fixed bed reaction tube 3, and a thermocouple is installed below the fixed bed reaction tube. The electrical signal detection and storage system includes a potential difference meter 8, a rechargeable battery 9, an external catalyst filling box 10, and an external catalyst 11.

Temperature measurement is carried out at the top of the fixed bed reaction tube, with an inlet on the side to ensure the temperature of the catalytic bed layer.

### EXAMPLE 1

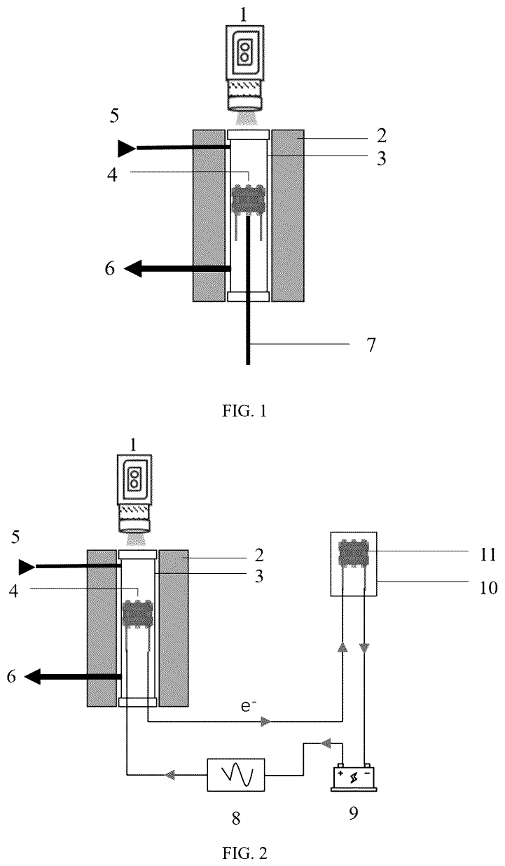

A fixed bed reactor suitable for in-situ heat removal and in-situ temperature measurement in gas-phase exothermic reactions, as shown in FIG. 1, comprising a heating jacket and a fixed bed reaction tube. The fixed bed reaction tube 3 is inserted into the heating jacket 2. The fixed bed reaction tube is equipped with a catalyst bed layer 4, which is a composite material of acetylene selective hydrogenation to ethylene catalyst and thermoelectric material. The upper and lower ends of the catalyst bed layer are equipped with terminal posts for connecting wires. The fixed bed reaction tube is equipped with inlet 5 and outlet 6 at both ends, with both inlet and outlet located on the side. The top material of fixed bed reaction tube 3 is replaceable. There is a thermocouple 7 inside the tube, with one end in contact with the catalyst bed and the other end extending outside the fixed bed reaction tube.

### EXAMPLE 2

As shown in FIG. 2, it is an electrical signal detection and storage system. The electrical signal detection and storage system includes a potential difference meter 8, a rechargeable battery 9, an external catalyst filling box 10, and an external catalyst 11. As mentioned above, the catalyst bed is equipped with terminal posts, which connect the catalyst, potentiometer, rechargeable battery, and external catalyst in a series circuit using wires. Based on the fixed bed reaction tube, catalyst bed 4 releases heat during the selective hydrogenation of acetylene, resulting in a temperature difference between catalyst 4 and external catalyst 11. According to the principle of thermoelectric, the thermoelectric material releases electrons through the entire series circuit and stores them in the rechargeable battery 9. By using a potential difference meter 8 to detect the intensity of electrical signals, temperature measurement can be achieved.

### EXAMPLE 3

As shown in FIG. 3, it is the catalyst loading and support frame. The catalyst support frame includes conductive aluminum material 12. Joint fastener (insulator) 13. Conductive aluminum rod 14. Upper terminal nut 16. Upper terminal post 17. Lower terminal post 18. Bottom terminal nut 19. Fix the upper and lower conductive aluminum materials with the catalyst module in the fixed bed reaction tube by using fastener 13. As mentioned earlier, one end of the conductive aluminum rod is connected to the upper conductive aluminum material, and the other end extends to the lower end of the catalyst bed and is connected to the upper terminal nut 16 and the upper terminal for connection to the series circuit.

### EXAMPLE 4

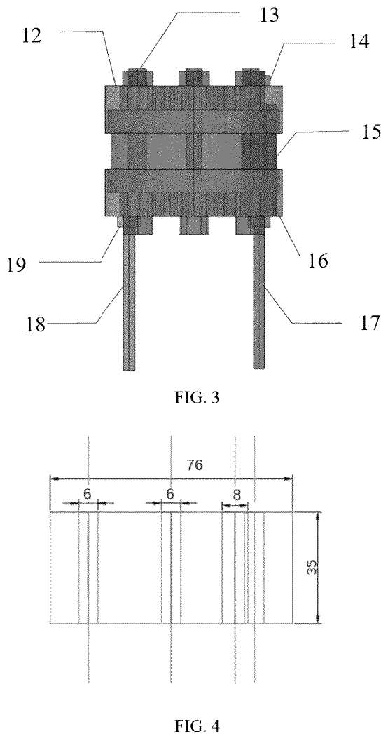

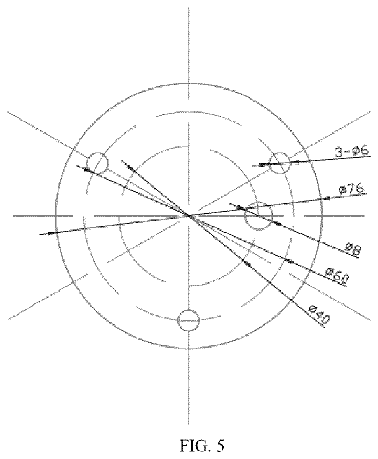

As shown in FIGS. 4 and 5, the schematic diagram of the catalyst. The catalyst is honeycomb shaped, and three additional holes for fastener 13 and conductive aluminum rod 14 are designed. The catalysts for selective hydrogenation of acetylene are Pd based, Ni based, and Cu based catalysts, and the thermoelectric material is the thermoelectric material bismuth telluride. The purchased acetylene selective hydrogenation catalyst is physically mixed with thermoelectric materials to form a composite material as a catalyst, which has hydrogenation performance for the reaction while removing the heat of the in-situ exothermic reaction.

What is claimed is:

1. A fixed bed reactor suitable for in-situ heat removal and in-situ temperature measurement in gas-phase exothermic reactions, comprising a heating jacket and a fixed bed reaction tube, wherein
the heating jacket is installed outside the fixed bed reaction tube, a catalyst bed is installed inside the fixed bed reaction tube, two ends of the fixed bed reaction tube are respectively equipped with inlet and outlet ports, a thermocouple is installed inside the fixed bed reaction tube, with one end extending to the catalyst bed and the other end extending outside the fixed bed reaction tube, and
the fixed bed reactor further comprises at least one of an electrical signal detection system, an electric energy storage system, and an infrared temperature measurement system.

2. The fixed bed reactor according to claim 1, wherein
the infrared temperature measurement system and the electrical energy storage system are installed at a top of the fixed bed reaction tube.

3. The fixed bed reactor according to claim 2, wherein
the top of the fixed bed reaction tube is made of germanium glass.

4. The fixed bed reactor according to claim 1, wherein
the electric energy storage system comprises rechargeable batteries, potential difference meters, external catalyst filling boxes, and external catalysts, the rechargeable battery, the potentiometer, the external catalyst filling box, and the catalyst bed are connected to form a closed circuit.
